(19) United States
(12) Patent Application Publication
(10) Pub. No.: US 2016/0294199 A1
(43) Pub. Date: Oct. 6, 2016

(54) Public Service and Charging Kiosk

(71) Applicant: Douglas N. Poffinbarger, II, Oceanside, CA (US)

(72) Inventor: Douglas N. Poffinbarger, II, Oceanside, CA (US)

(21) Appl. No.: 15/085,991

(22) Filed: Mar. 30, 2016

Related U.S. Application Data
(60) Provisional application No. 62/141,170, filed on Mar. 31, 2015.

(51) Int. Cl. H02J 7/00; H02J 7/35; H02J 7/02; H04W 4/22; H04W 88/08; G06Q 30/02; G06F 3/0488; H02S 20/23; B60L 11/18

(52) U.S. Cl. CPC H02J 7/0027; H02S 20/23; H02J 7/355; H02J 7/025; B60L 11/182; B60L 11/1825; H04W 88/08; G06Q 30/0241; G06F 3/0488; H04W 4/22

(57) ABSTRACT

An autonomous public service and utility providing kiosk apparatus, system and methods are disclosed herein. One particular example includes a structure for an outdoor transit stop for use in bus or rail lines and routes. Many features are optionally provided by the kiosk including: video, audio, interactive display, Internet access, electronic device charging, to name a few. Also optionally, autonomy is provided by photovoltaic solar panels, thereby obviating a need for utility power. The invention can additionally be retrofitted to an existing transit stop or be a new stand alone structure.

### PRIORITY CLAIM

This patent application claims benefit of the priority date of U.S. Prov. Pat. App. Ser. No. 62/141,170 filed on Mar. 31, 2015 entitled “Public Service and Charging Station;” accordingly, the entire contents of this patent submission is hereby expressly incorporated by reference.

### BACKGROUND OF THE INVENTION

1. Field of the Invention

The present invention pertains generally public services such as the Internet, bus and train transportation, and public utilities such as electricity and the cellular phone network. More particularly, in a preferred embodiment, the invention relates a solar powered, smart, outdoor structure (such as transportation terminal or urban shelter) providing a variety of public services as detailed herein.

2. Description of the Prior Art

Heretofore, kiosks that provide 120V power have been known, as well as public lighting fixtures that run on solar power. One pertinent example was proposed by Langlois et al. entitled, “Solar Powered Bus Stop” US Pub. Pat. App. No. 2006/0120068. In that example, a solar powered post is configured with lights, wherein visual indication lights are provided in addition to push buttons for user functionality.

While Langlois and his co-inventors have provided a useful contribution, it's now over a decade obsolete. A newer innovation is presently needed in the art particularly due to advances in low power, wireless transmission, and advances in solar cell as well as numerous other technologies.

Comparable prior art designs are limited to standalone structures for charging portable electronic devices at a static kiosk or trailhead. Some bus shelter manufacturers have simply added a solar powered light fixture to a bus stop shelter. However, none provide a comprehensive set of services beyond lighting or device charging.

Also concurrently, public transit agency officials that plan operations are continuously looking for ways to improve ridership after sunset. Providing well lighted public areas with additional safety features is seen as a first step in improving patronage of such transit services.

Accordingly, a first object of the present invention is to provide various public services at a transit stop, shelter, gathering place or signage location. It is an additional object of the present invention to provide a resilient network, independent to other physical locations of an electrical grid, and inherently isolated from any faults that may occur in a wired network (for e.g. power lines connected to traditional telephone poles are particularly vulnerable during a tropical storm). It is still an additional object of the present invention to provide a public charging station that is user interactive and able to recognize individual users.

It is yet still further an object of the present invention to provide a design that includes a variety of innovative features and applications over prior solar powered integrated structures.

### BRIEF SUMMARY OF THE INVENTION

The present invention specifically addresses and alleviates the above mentioned deficiencies, more specifically, the present invention in a first aspect is a kiosk comprising: a rectangular upright structure having a front and a back and lateral sides; a first signage configured to said front; a charging port for charging electronic devices; a canopy configured at an upper portion of said upright rectangular (rectilinear) structure, the canopy for providing shade and overhead shelter for a user; and a plurality of solar (photovoltaic) cells configured to the canopy for providing off-the-grid power to the kiosk, the canopy further having lateral sides further including signage configured to a one said lateral sides.

In still a second aspect, the invention is a charging kiosk comprising: a rectangular upright structure having a front and a back and lateral sides; a first signage configured to said front; a window carve-out from said front through to said back; and a charging port for charging electronic devices configured to the window carve-out at an inside frame thereof.

Further in this aspect, the invention is characterized as comprising a second signage configured to said front wherein the first signage comprises advertising information and wherein the second signage comprises public transit information including real-time information. Also the invention includes a wireless access point for providing wireless Internet access to a plurality of persons; and a climate sensing device (temperature or barometric pressure, wind speed, for example) for providing weather data input to a central reporting and forecasting system.

The charging kiosk herein also includes an interactive display comprising a graphical user interface including a touch user interface. Further the invention is characterized wherein the charging port is a wireless charger (for example and inductive charger have a primary coil configured to the charger and a secondary coil configured to the device to be charged such as a cellular phone). Additionally still the invention includes an emergency alert button for providing public safety (or private security officials) indication of a user needing assistance; and a microphone (e.g. emergency intercom) providing voice connection to public safety (or private security) officials.

Also the invention includes a lighting system including a light sensor for command and control input to the lighting system. Still further the invention comprises a video camera for taking and recording video images (for example, a security camera).

Importantly, especially an outdoor charging kiosk, includes a canopy configured at an upper portion of said upright rectangular (rectilinear) structure, the canopy for providing shade and overhead shelter for a user; and a plurality of solar (photovoltaic) cells configured to the canopy for providing off-the-grid power to the kiosk, the canopy further having lateral sides further including signage configured to said lateral side.

Also, the kiosk could be part of a retrofit wherein the rectangular upright structure is configured as a portion of a wall of an existing outdoor transit structure thereby providing a retrofit to an existing transit stop.

The charging kiosk further comprises a plurality of symbols on a side thereof to inform users that public services are provided, the plurality of symbols comprising: an emergency call symbol; an Internet access point symbol; and an electronic charging provider symbol.

Still further in a third aspect, the invention may be characterized as a transit stop comprising: an upright elongated post; and a canopy roof portion cantilevered to the elongated post, the canopy roof portion further having a top, a bottom and lateral sides, the lateral sides configured with signage. Further the transit stop is characterized wherein the upright elongated post together with the canopy roof form a first modular section wherein second and subsequent identical modular portions are connected to the first modular section.

As in earlier embodiments, the transit stop further comprises a wireless access point for providing wireless Internet access to a plurality of persons; and a video camera for taking and recording video images (for example, a security camera).

The transit stop of the present invention is further characterized in that the canopy roof portion further comprising: a plurality of solar (photovoltaic) cells configured thereto for providing off-the-grid power to the transit stop, the canopy further having lateral sides further including signage configured to said lateral sides. The post also has a plurality of symbols on a side thereof, the plurality of symbols comprising: an Internet access point symbol; and an electronic charging provider symbol.

While the apparatus and method has or will be described for the sake of grammatical fluidity with functional explanations, it is to be expressly understood that the claims, unless expressly formulated under 35 USC §112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC §112 are to be accorded full statutory equivalents under 35 USC §112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective view of a first preferred smart kiosk embodiment of the present invention;

FIG. 1B is a second perspective view thereof from an elevated vantage point;

FIG. 1C is an enlarged view of an upright rectangular structure of the first preferred kiosk;

FIG. 1D is an additional enlarged view of an inside window frame portion of the first preferred embodiment;

FIG. 1E is a perspective view of a retrofit invention embodying the first preferred kiosk;

FIG. 2A is a perspective view of a post and cantilevered canopy embodiment of the present invention;

FIG. 2B is an additional perspective view of a second preferred embodiment illustrating modularity thereof; and

FIG. 2C is an additional perspective view.

### DESCRIPTION OF PREFERRED EMBODIMENTS

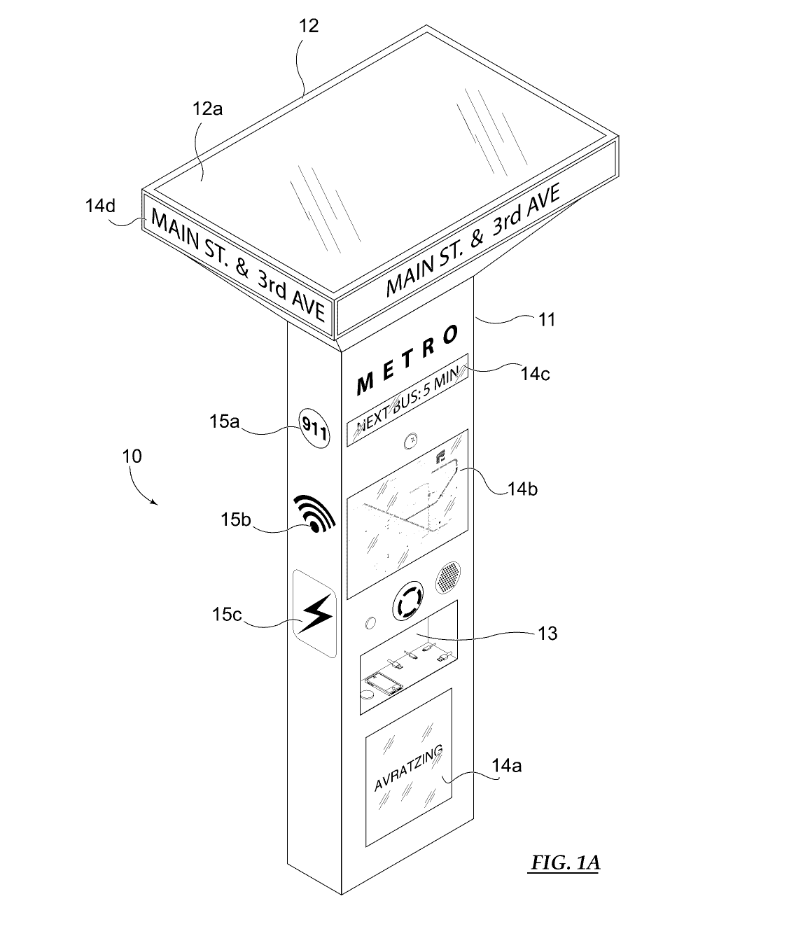

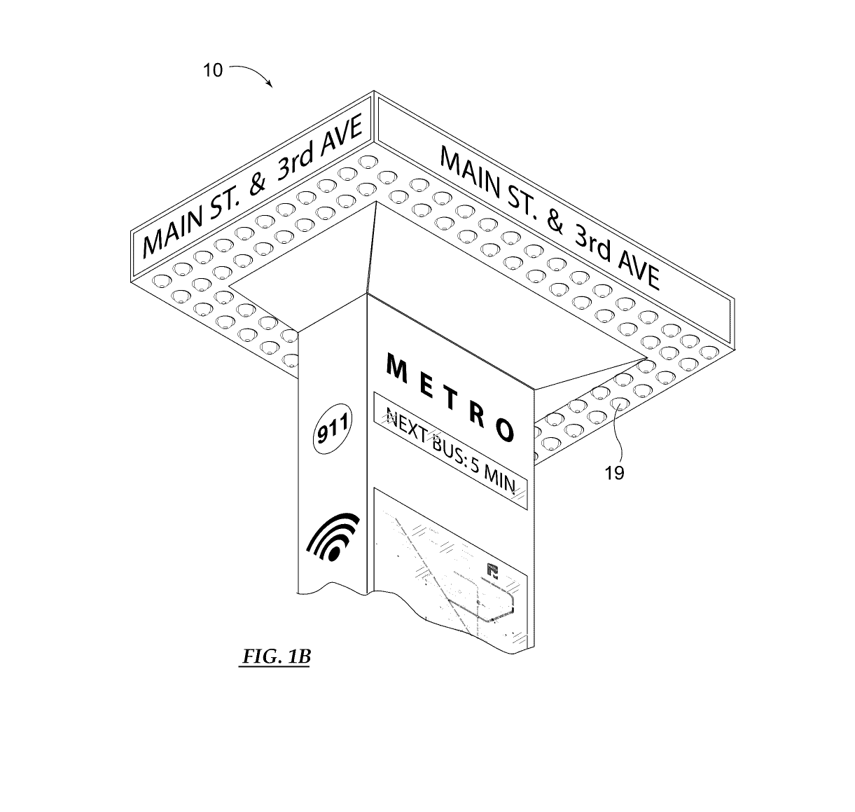

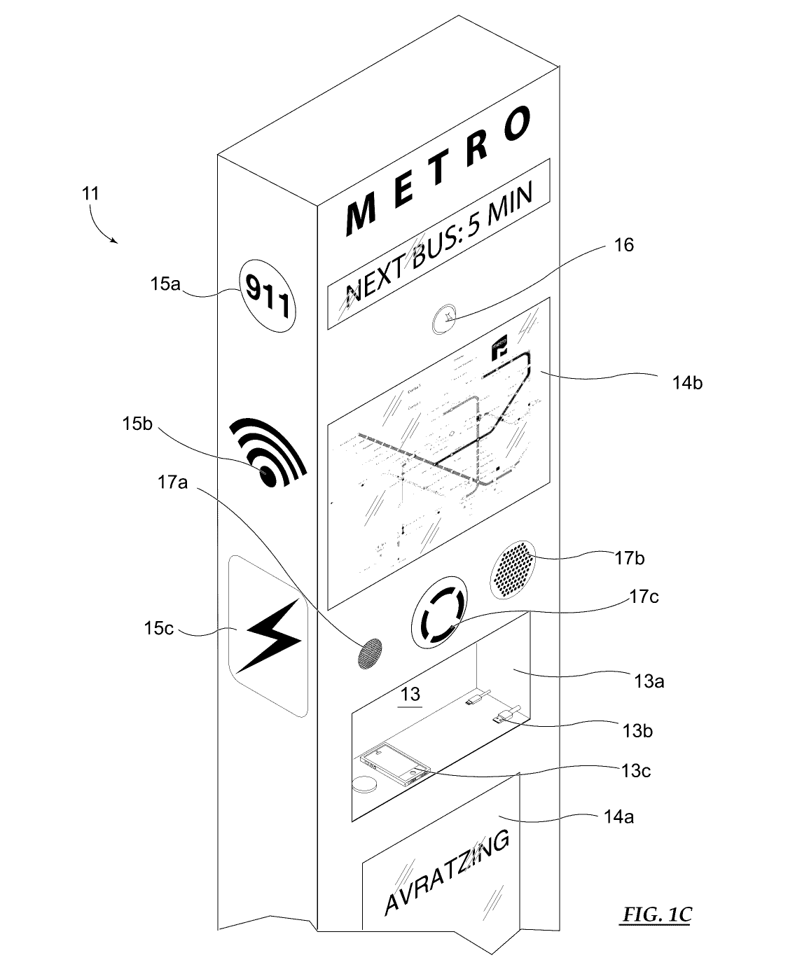

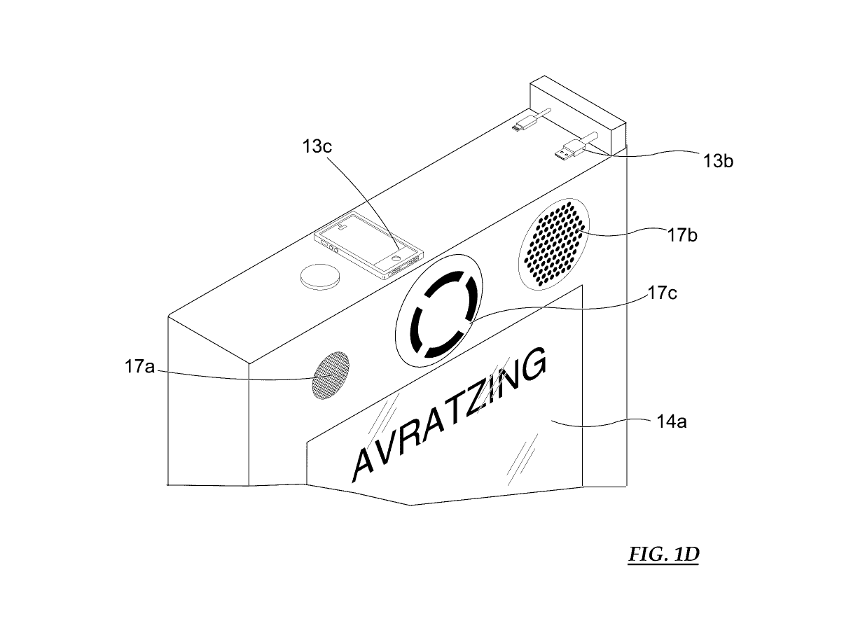

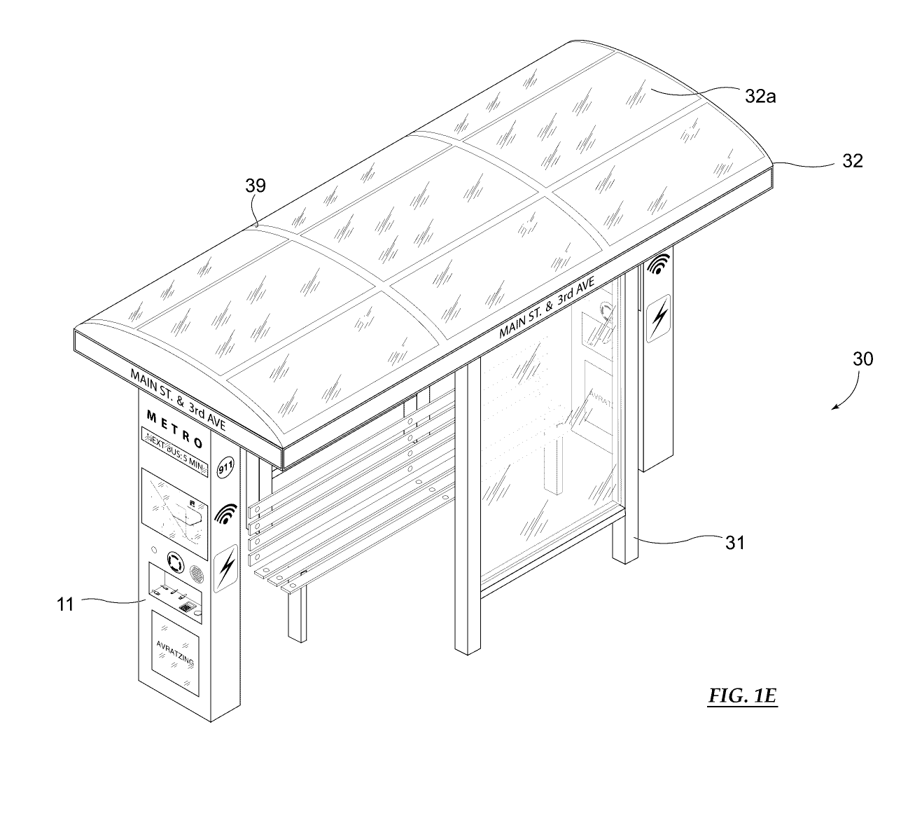

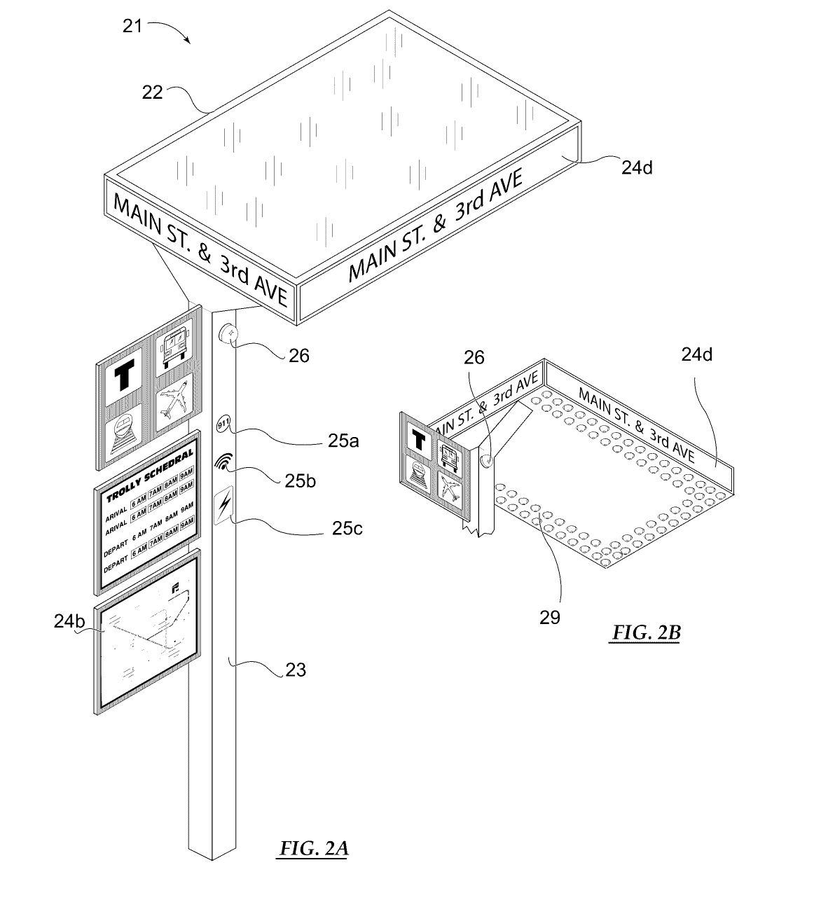

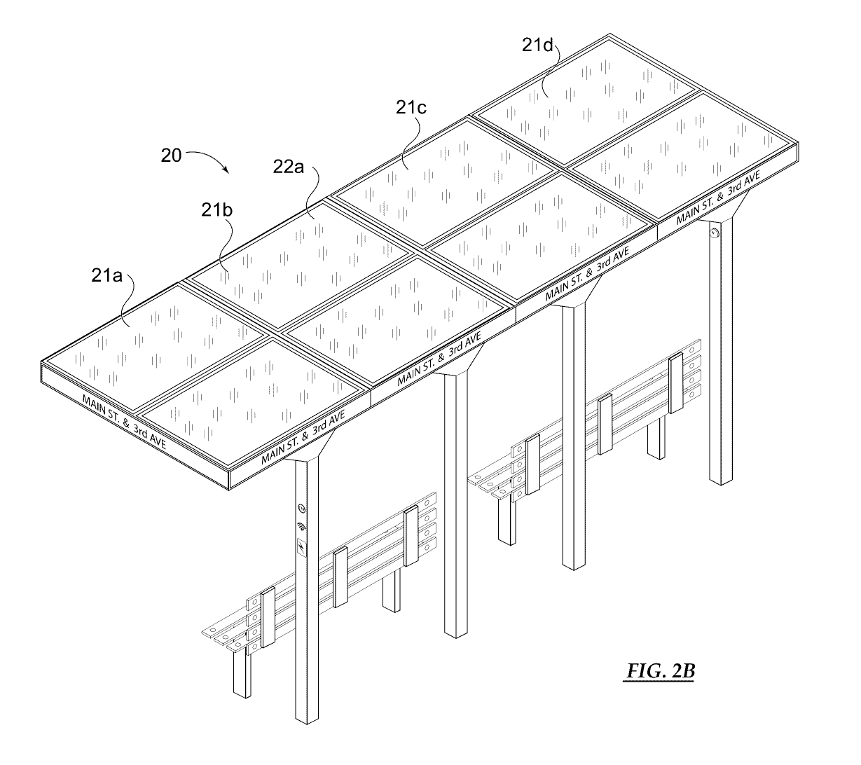

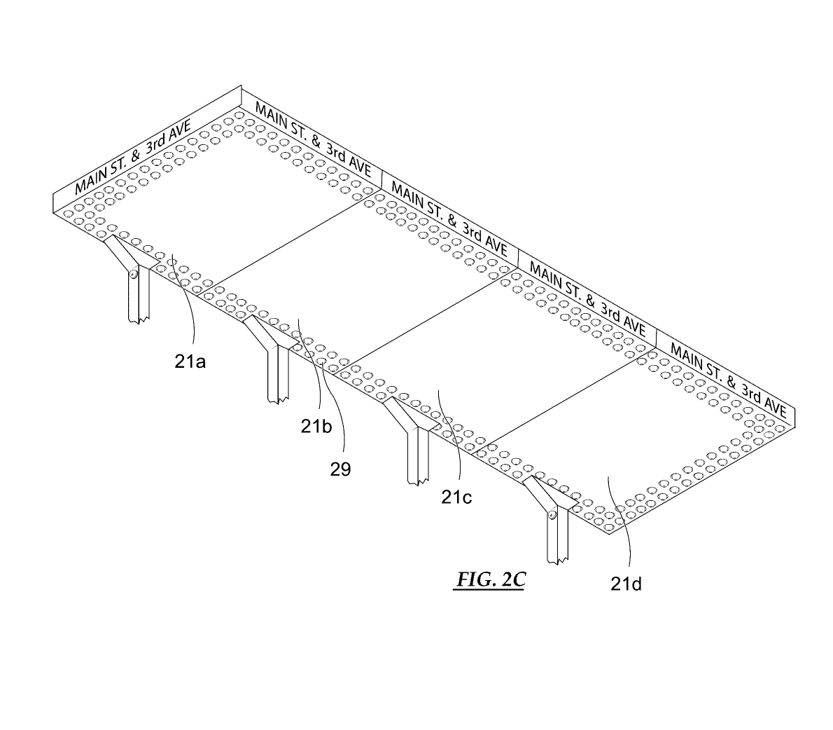

Referring initially to FIG. 1A (and FIG. 2A), a first preferred embodiment 10 is illustrated as an artist rendition. Initially, a kiosk 10 may be defined as a small or medium size structure 11 in a public area used for providing information or displaying advertisements 14a, often incorporating an interactive display screen 14b or screens. Also in this aspect, the invention 10, 20, 30 is a system that comprises a solar powered outdoor smart charging kiosk 11, 21 that integrates and provides various features such as: emergency alerts 14c, 24d, video capture 16, 26 and 2-way intercom (microphone 17a plus speaker 17b); controllable and programmable ambient and architectural lighting 19, 29; digital wayfinding 14b, 24b and advertising displays 14a; environmental sensing and remote data feed, localized weather feeds; free charging 13b, 13c for mobile devices, laptops and gadgets; public and secure WiFi 15b or other modern communications; environmental comfort such as radiant heating or misters for cooling; solar panels 12a, 22a, 32a and energy storage (battery) for long duration or continuous availability without burning fossil fuels for power, or paying utility bills, or the expense of running underground power lines.

Also referring to FIG. 1A through FIG. 1D, additional features of the present invention include but are not limited to: radio frequency communications 17a, 17b, WiFi communications 15b, 25b, internet access, lighting 19, 29, 39, low voltage charging 13b (for mobile devices), standard voltage charging (for portable computers and appliances), higher voltage charging (for electric vehicles), digital touch screen 14b, ultra-low energy using digital signage 14c, 24d, video camera, 16, 26 speakers 17b and microphone 17a for public address and public safety, environmental sensors, motion/light sensors and a battery for storing electricity.

More specifically with regard to FIG. 1A, FIG. 1B, FIG. 1C a charging kiosk 10 is shown in various views. Initially, a rectangular upright structure portion 11 provides various features to bus or rail traveler, for example. A first signage 14a is configured to a front of the upright structure comprising advertisement. A second signage 14b could also be an interactive user touch screen 14b or simply be a public transit real-time information screen. Importantly, with regard to FIG. 1C and FIG. 1D, a window carve-out 13 from a front entirely through to a back of the upright structure 11 is provided and contains charging features 13b and 13c that may comprise wireless charging 13c. Features 13b, 13c are provided about an inside window frame 13a thereof 13.

It is further contemplated herein that all embodiments 10, 20, 30 herein may contain a climate sensing device (temperature or barometric pressure, wind speed, for example) for providing weather data input to a central reporting and forecasting system.

With regard to FIG. 1D, the charging kiosk 21 further includes an emergency alert button 17c for providing public safety (or private security officials) indication of a user needing assistance; and a microphone 17a plus speaker 17b (e.g. emergency intercom) providing voice connection to public safety (or private security) officials.

With regard to FIG. 1A and FIG. 2A, lights 19, 29 are provided around an outer periphery of canopy portion 12, 22. It is additionally contemplated herein the invention 10, 20, 30 has a smart lighting system having sensors (ambient light) for command and control input to the lighting system. As stated, security cameras 16, 26 are provided particularly useful to safety and law enforcement personnel.

Importantly, a canopy 12, 22, 32 is configured in all embodiments 10, 20, 30 with solar cells 12a, 22a, 32a. With regard to FIG. 1A and FIG. 1B, the canopy 12 is configured at an upper portion of the upright rectangular (rectilinear) structure 11; the canopy 12 provides shade and overhead shelter for a user. The plurality of solar (photovoltaic) cells 12a is configured to the canopy 12 for providing off-the-grid power to the kiosk 10; the canopy 12 (canopy 22, FIG. 2A) additionally has lateral sides further including signage 14d, 24d configured to the lateral side. The signage 14d, 24d may include real-time updated information.

As best shown in FIG. 1C, the upright structure 11 has information symbols on a side thereof showing users services provided by the kiosk 10. These include: an emergency call symbol 15a; an Internet access point symbol 15b; and an electronic charging 15c provider symbol.

Also with regard to FIG. 1C, digital display 14b (interactive, for example) can provide riders with next pickup schedule information at a glance and coordinated with shelter lighting 19, 29, 39 to alerts drivers and riders.

With reference to FIG. 1D, emergence/panic button 17c starts intercom 17a, 17b with public safety officials. Video 16, 26 captures may be initiated automatically. IP or cellular address can be flagged for review by safety officials. Subsequently, lights 19, 29, 39 automatically change to bright blue, making location standout for safety officials. Audio tones 17b or commands are available as well.

With regard to FIG. 1E, the charging kiosk rectangular upright structure 11 is configured as a portion of a wall 31 of an existing outdoor transit structure 30 thereby providing a retrofit to an existing transit stop. Lights 39 and solar cells 32a are further retrofitted to the existing structure 31 as shown.

In still another aspect according to FIG. 1E, the invention may be characterized as a method of retrofitting 30 a shelter 31 such as a bus stop bench shelter comprising the steps of: configuring solar panels 32a to a shelter canopy 32; powering a lighting system 39 with the solar panel 32a providing electrical current thereto; providing wireless Internet access 15b to the shelter 31; and configuring a sensor providing real-time data to a central database.

Public WiFi is available for local users. It may be ad-supported to provide by the owner as a free service. Secure WiFi is used for GPS/scheduling, emergency video feeds/recording and communications. Public safety data and shelter 10, 20, 30 status information is transmitted via a secure VPN connection.

With reference to FIG. 2A, FIG. 2B and FIG. 2C, a transit stop 21 embodiment 20 is provided that may include several modules 21a, 21b, 21c, 21d. Or stated differently, second 21b and subsequent 21c, 21d identical modular portions are connected to the first modular section 21a.

Basically, a transit stop 21 module includes: an upright elongated post 23; and a canopy roof portion 22 cantilevered to the elongated post 23. As in common with the first embodiment 10, canopy roof portion 22 further has a top, a bottom and lateral sides, the lateral sides configured with signage 24d. The top is configured with solar cells 22a and the bottom is configured with LED lights 29 around and outer periphery thereof Also as before, a video camera 26 is provided for taking and recording video images (for example, a security camera). Symbols such as an Internet access point symbol 25b, and an electronic charging provider symbol 25c, are provided. An interactive display 24b may additionally be configured to the transit stop 21.

Additional kiosk features include lighting 19, 29, 39 command and control in coordination with other nearby stations for safety, aesthetics and street scenes. Automatic light sensors adjust lights 19, 29, 39 with ambience and occupancy. Lighting intensity may vary for example to alert approaching bus or train operator of waiting passengers. Motion detectors may optionally added varying light intensity. Audio signal alerts (via speaker 17b) are also optional.

Autonomous stations 10, 20, 21, 30 provided by the present invention address multiple problems which bring added value and customer loyalty for owners and sponsors. The present invention further addresses challenges such as difficulty providing utility or grid power to new locations in an urban or remote location in that this is typically very expensive and often cost prohibitive. Also, underground trenching, subsequent required street and sidewalk repairs can often cost $20,000-$30,000 per location. These figures will likely increase over time.

Other challenges addressed by the present invention include: supplying grid utility power to the millions of public spaces without power is cost prohibitive and would be highly polluting using utility power originating from burning fossil fuels; and adding new services and monitoring for public spaces is aesthetically crowding making some areas look blighted.

Another need addressed by the present invention is that prior art public transit stops are typically unlit. As a result, they are largely unsafe at night and result in practically nonexistent ridership at night. As a result, transit agency revenues are significantly less what they should be and use of inefficient gasoline powered automobiles could be reduced therefore minimizing pollution and resultant environmental effect.

The present invention has many unique aspects and novel features. For example, the public utility system and service as detailed herein is the first solar powered retrofit 30 for transit stations that further integrates public services beyond lighting. Additionally still, it should be appreciated that the invention is the first self-contained autonomous retrofit 30 for public infrastructure that enables a variety of public safety and public service features beyond lighting and device charging.

Also as illustrated and described herein, the present invention 10, 20, 30 includes: an emergency panic button 17c to initiate emergency communications with public safety officials; a microphone 17a, speaker 17b and video camera 16, 26 for real-time communications and alerts; digital displays 14b for schedules, alerts, advertisements 14a and other real-time information; various sensors for tracking occupancy, usage, local weather and other important data; battery storage to ensure resilient and long term availability and reliability; solar power 12a, 22a, 32a or solar power inputs to eliminate the expense of delivering power and the buying energy; wireless 13c and traditional plug-in 13b adapters for recharging mobile devices while waiting or gathering; environmental comfort such as radiant heating or misters for cooling; and AC power inputs for additional backup power if desired; and remote programming capability for adjusting and/or customizing features of the smart stations 10, 20, 30.

As stated, the present invention adds solar power and lights 19, 29, 39 to transit stops 10, 20, 30 to making riders feel safer while eliminating the need to bring outside power to the site. Cofiguring overhead space with solar shall avail extra power for other services such as communications, device charging 13b, 13c area and architectural lighting and more. With the addition of wireless communications 15b, 25b a host of other services became available: emergency communications (e.g. audio 17b, video 16, 26), emergency alerts and notifications (audio 17b, video 16, 26 lighting 19, 29, 39), weather and other sensor data.

Direct results of implementation of the present invention include: ridership increase; added revenue from increased ridership; added revenue from advertising 14a; feeling of public security; installation savings; energy savings; carbon savings from power to station; and carbon savings as a result of increased ridership.

Additional effects deemed indirect results of the present invention include: transit agency received awards for smart connected, sustainable transportation; city received rewards for environmental sustainability and connectedness; reduced crime; and attracted new high tech business which brings in much higher revenue per capita.

In yet another aspect, the present invention comprises a smart electronic device mobile application that is able to interact with a user, for e.g. providing information on selective data; or offering a rewards program, or providing a pop-up screen for user selection and interaction. Further in this embodiment, the mobile device application is able to recognize a user and contains stored and updated data. The application additionally provides information on the nearest station 10, 20, 30 and details on the type of station and its relative availability. Particularly, an automatic alert is generated identifying nearest station when mobile device battery charge is low. Digital maps herein are further configured with touch screen user input.

One or more of the embodiment described herein also comprise electronic (residual) 14c, 14d, 24d ink that requires no or minimal power when the digital screen remains unchanged.

Variants or alternative approaches of the invention include: solar post “sunpost” pylon design; solar monolith “sunsign” design; monolith design (¾ monolith); smart shelter retro-kit (½ monolith).

In still another aspect the invention is a method of providing public services comprising the steps of: providing a structure 10, 21 configured for persons to gather; powering the structure with solar energy 12a, 22a; connecting the persons to information and data via an Internet access point 15b, 25b configured to the structure 10, 21; providing a charging port 13b, 13c to the structure thereby providing electronic device charging services to the persons; and conveying information to the public using a plurality of lights 19, 29 wherein the conveying comprises varying color and intensity of the plurality of lights.

It should be understood, of course, that the foregoing relates to exemplary embodiments of the invention and that modifications may be made without departing from the spirit and scope of the invention as set forth in the following claims.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Public Service and Charging Kiosk herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A kiosk comprising:
a rectangular upright structure having a front and a back and lateral sides;
a first signage configured to said front;
a charging port for charging electronic devices;
a canopy configured at an upper portion of said upright rectangular structure, the canopy for providing shade and overhead shelter for a user; and
a plurality of solar cells configured to the canopy for providing off-the-grid power to the kiosk, the canopy further having lateral sides further including signage configured to a one said lateral sides.

2. A charging kiosk comprising:
a rectangular upright structure having a front and a back and lateral sides;
a first signage configured to said front;
a window carve-out from said front through to said back; and
a charging port for charging electronic devices configured to the window carve-out at an inside frame thereof.

3. The charging kiosk of claim 2, further comprising a second signage configured to said front wherein the first signage comprises advertising information and wherein the second signage comprises public transit information including real-time information.

4. The charging kiosk of claim 2, further comprising:
a wireless access point for providing wireless Internet access to a plurality of persons; and
a climate sensing device for providing weather data input to a central reporting and forecasting system.

5. The charging kiosk of claim 2, further comprising an interactive display comprising a graphical user interface including a touch user interface.

6. The charging kiosk of claim 2, wherein the charging port is a wireless charger.

7. The charging kiosk of claim 2 further comprising:
an emergency alert button for providing public safety indication of a user needing assistance; and
a microphone providing voice connection to public safety officials.

8. The charging kiosk of claim 2 further comprising a lighting system including a light sensor for command and control input to the lighting system.

9. The charging kiosk of claim 2 further comprising a video camera for taking and recording video images.

10. The charging kiosk of claim 2 further comprising:
a canopy configured at an upper portion of said upright rectangular structure, the canopy for providing shade and overhead shelter for a user; and
a plurality of solar cells configured to the canopy for providing off-the-grid power to the kiosk, the canopy further having lateral sides further including signage configured to said lateral side.

11. The charging kiosk of claim 2 wherein the rectangular upright structure is configured as a portion of a wall of an existing outdoor transit structure thereby providing a retrofit to an existing transit stop.

12. The charging kiosk of claim 2, further comprising a plurality of symbols on a side thereof, the plurality of symbols comprising:
an emergency call symbol;
an Internet access point symbol; and
an electronic charging provider symbol.

13. A transit stop comprising:
an upright elongated post; and
a canopy roof portion cantilevered to the elongated post, the canopy roof portion further having a top, a bottom and lateral sides, the lateral sides configured with signage.

14. The transit stop of claim 13 wherein the upright elongated post together with the canopy roof form a first modular section wherein second and subsequent identical modular portions are connected to the first modular section.

15. The transit stop of claim 13, further comprising:
a wireless access point for providing wireless Internet access to a plurality of persons; and
a video camera for taking and recording video images.

16. The transit stop of claim 13, the canopy roof portion further comprising: a plurality of solar cells configured thereto for providing off-the-grid power to the transit stop, the canopy further having lateral sides further including signage configured to said lateral sides.

17. The transit stop of claim 13, further comprising a plurality of symbols on a side of said elongated post, the plurality of symbols comprising:
an Internet access point symbol; and
an electronic charging provider symbol.
